(19) United States
(12) Patent Application Publication
(10) Pub. No.: US 2026/0001594 A1
(43) Pub. Date: Jan. 1, 2026

(54) MULTI-FUNCTIONAL TAILGATE

(71) Applicant: Scout Motors, Inc., Tysons, VA (US)

(72) Inventor: Pat Vostal, Plymouth, MI (US)

(21) Appl. No.: 18/757,160

(22) Filed: Jun. 27, 2024

(51) Int. Cl. B62D 33/027; B60R 3/02

(52) U.S. Cl. CPC B62D 33/0273; B60R 3/02

(57) ABSTRACT

A multi-function tailgate may include an inner facia. A multi-function tailgate may include a slide assembly coupled to the inner facia. A multi-function tailgate may include a platform coupled to the slide assembly, wherein the platform is movable between a stowed position, a work position, a bed extender position, and a step position.

### BACKGROUND

This disclosure relates to tailgates for vehicles. More specifically, this disclosure relates to vehicle tailgates with extendable work surfaces and steps.

### SUMMARY

In some aspects, the techniques described herein relate to a multi-function tailgate including: an inner facia; a slide assembly coupled to the inner facia; and a platform coupled to the slide assembly, wherein the platform is movable between a stowed position, a work position, a bed extender position, and a step position.

In some aspects, the techniques described herein relate to a multi-function tailgate, wherein the inner facia includes a facia recess sized to receive the platform.

In some aspects, the techniques described herein relate to a multi-function tailgate, wherein the platform extends out of the facia recess when arranged in the work position.

In some aspects, the techniques described herein relate to a multi-function tailgate, wherein the platform includes a generally planar work surface that is flush with the inner facia when the platform is in the stowed position and in the work position.

In some aspects, the techniques described herein relate to a multi-function tailgate, wherein the inner facia includes a slide recess sized to receive the slide assembly.

In some aspects, the techniques described herein relate to a multi-function tailgate, wherein the slide assembly includes a slide link slidingly coupled to the slide recess, and a pivot link rotationally coupled to the slide link and rotationally coupled to the platform.

In some aspects, the techniques described herein relate to a multi-function tailgate, wherein the slide link and the pivot link are arranged linearly when the platform is arranged in the work position and the bed extender position.

In some aspects, the techniques described herein relate to a multi-function tailgate, wherein the pivot link is arranged oblique to the slide link when the platform is arranged in the step position.

In some aspects, the techniques described herein relate to a multi-function tailgate, wherein the platform includes two platform brackets rotationally coupled to the slide assembly and limiting rotation of the platform relative to the slide assembly.

In some aspects, the techniques described herein relate to a multi-function tailgate, wherein the platform is rotated oblique to the inner facia when the platform is arranged in the bed extender position.

In some aspects, the techniques described herein relate to a multi-function tailgate, wherein the slide assembly is extended out of the inner facia when the platform is arranged in the bed extender position.

In some aspects, the techniques described herein relate to a multi-function tailgate, wherein the platform includes an array of clamping holes.

In some aspects, the techniques described herein relate to a multi-function tailgate, wherein the clamping holes define a non-slip step surface and an opposing, smooth, generally planar work surface.

In some aspects, the techniques described herein relate to a multi-function tailgate, wherein the inner facia includes a protractor, a ruler, or cup holders.

In some aspects, the techniques described herein relate to a multi-function tailgate, wherein the slide assembly includes a platform button release selectively locking the platform in the stowed position, the work position, the bed extender position, and the step position.

In some aspects, the techniques described herein relate to a multi-function tailgate including: an inner facia defining a facia recess; a platform sized to be received within the facia recess and including a generally planar work surface and a step surface; and a slide assembly including a slide link slidable relative to the inner facia and a pivot link rotationally coupled to the slide link and rotationally coupled to the platform, wherein the multi-function tailgate is moveable between: a stowed position with the platform received within the facia recess and the generally planar work surface flush with the inner facia, a work position with the slide link and the pivot link linearly aligned and extending at least partially from the inner facia so that the generally planar work surface of the platform extends at least partially out of the facia recess with the generally planar work surface flush with the inner facia, and a step position with the slide link extended from the inner facia, the pivot link rotated relative to the slide link, and the platform rotated relative to the pivot link so that the step surface is usable as a step.

In some aspects, the techniques described herein relate to a multi-function tailgate, wherein the multi-function tailgate is further moveable to a bed extender position with the platform rotated relative to the pivot link so that the step surface is arranged oblique to the inner facia.

In some aspects, the techniques described herein relate to a multi-function tailgate, wherein the platform includes an array of clamping holes.

In some aspects, the techniques described herein relate to a multi-function tailgate including: an inner facia; a slide assembly slidably coupled to the inner facia; and a platform rotationally coupled to the slide assembly and including a work surface and a step surface, wherein the multi-function tailgate is moveable between: a stowed position with the work surface flush with the inner facia, a work position with the slide assembly extending at least partially from the inner facia and the work surface flush with the inner facia and extending therefrom to increase a usable area of the multi-function tailgate, a bed extender position with the platform rotated relative to the slide assembly so that the step surface is arranged oblique to the inner facia, and a step position with the platform rotated relative to the slide assembly so that the step surface is usable as a step.

In some aspects, the techniques described herein relate to a multi-function tailgate, wherein the step surface is parallel to and offset from the inner facia in the step position.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale.

FIG. 1A is a perspective view of a multi-function tailgate in a stowed position, according to some implementations.

FIG. 1B is a schematic view of the multi-function tailgate of FIG. 1A, according to some implementations.

FIG. 2A is a perspective view of the multi-function tailgate of FIG. 1A in a work position, according to some implementations.

FIG. 2B is a schematic view of the multi-function tailgate of FIG. 2A, according to some implementations.

FIG. 3A is a perspective view of the multi-function tailgate of FIG. 1A in bed extender position, according to some implementations.

FIG. 3B is a schematic view of the multi-function tailgate of FIG. 3A, according to some implementations.

FIG. 4A is a perspective view of the multi-function tailgate of FIG. 1A in a step position, according to some implementations.

FIG. 4B is a schematic view of the multi-function tailgate of FIG. 4A, according to some implementations.

FIG. 5 is a top view of a multi-function tailgate, according to some implementations.

FIG. 6 is a section view of a platform of the multifunction tailgate of FIG. 5, according to some implementations.

### DETAILED DESCRIPTION

Following below are more detailed descriptions of concepts related to, and implementations of, methods, apparatuses, and systems for a multi-function tailgate. The figures illustrate exemplary implementations in detail and the present disclosure is not limited to the details or methodology set forth in the description or illustrated in the figures. The terminology used herein is for the purpose of description only and should not be regarded as limiting.

Referring to the figures generally, the various implementations disclosed herein relate to systems, apparatuses, and methods for a multi-function tailgate for a vehicle. The multi-function tailgate includes tailgate inner facia and a platform defining a work surface (e.g., including a ruler, a protractor, a bottle opener, cup holders, clamp holes, electrical outlets, etc.) that is positioned in plane with the rest of the tailgate inner facia and a step surface opposite the work surface that can be used as a step or seat. The platform is deployable between a stowed position, a work position with the platform extended from the tailgate and still planar with the tailgate inner facia, a bed extender position with the platform flipped up and extended from the tailgate inner facia to extend the usable space of a truck bed, and a step position with the platform extended from the tailgate inner facia and lowered so that a user can use the step surface to aid entry to the truck bed or use the step surface as a seat.

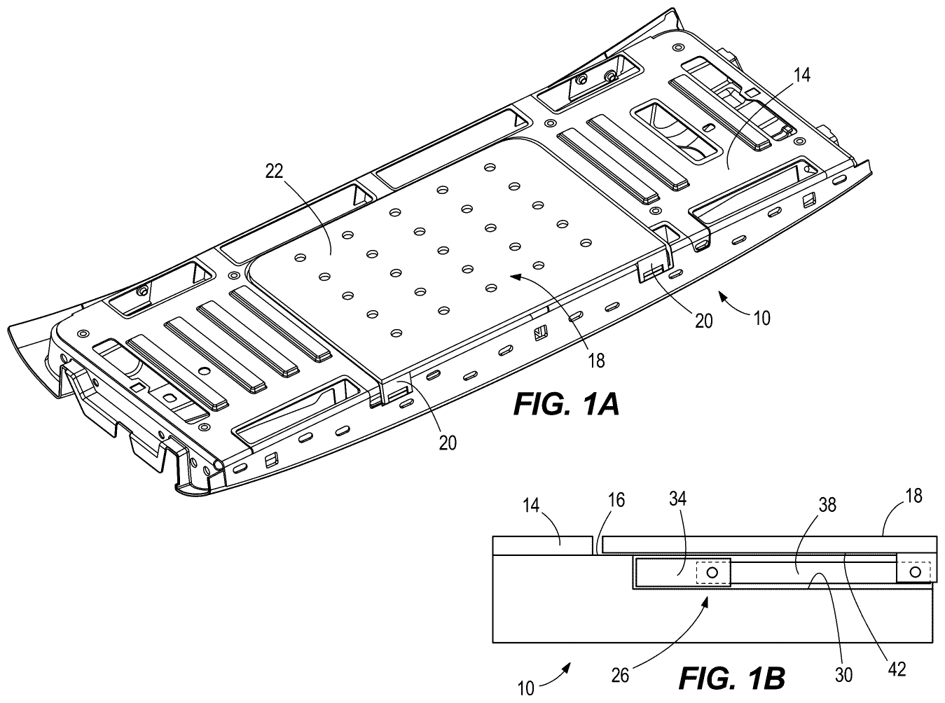

As shown in FIGS. 1A and 1B, a multi-function tailgate 10 is structured to be hingedly connected to a vehicle (e.g., a battery electric vehicle, a pickup truck, a sport utility vehicle, etc.) and includes an inner facia 14. The multi-function tailgate 10 is movable relative to the vehicle between a closed position with the inner facia 14 generally vertical and an open position with the inner facia 14 generally horizontal. In some implementations, the inner facia 14 defines a facia recess 16.

A platform 18 including two platform brackets 20 is connected to the multi-function tailgate 10 via a slide assembly 26. The platform 18 is shaped to fit within the facia recess 16 and includes a generally planar work surface 22. In some implementations, the generally planar work surface 22 is sized so that the work surface 22 is flush with or generally planar with the inner facia 14.

The slide assembly 26 includes two subassemblies each received within a slide recess 30 formed in the multi-function tailgate 10 and including a slide link 34 that is slidingly engaged with the slide recess 30, and a pivot link 38 that is rotatably connected between the slide link 34 and one of the platform brackets 20. In some implementations, the slide recess 30 is formed in a frame or structural support of the multi-function tailgate 10. In some implementations, the slide recess 30 is formed in the inner facia 14. In some implementations, the slide recess 30 is visible when the facia recess 16 is exposed (e.g., when the platform 18 is extended). In some implementations, the slide recess 30 are fully hidden within the inner facia 14 so that even when the facia recess 16 is exposed, the slide recess 30 is not visible.

As shown in FIG. 1B, while the multi-function tailgate 10 is arranged in a stowed position, the slide assembly 26 is retracted into the slide recesses 30, and the platform 18 is fully received within the facia recess 16 so that the work surface 22 is flush with the inner facia 14. When the multi-function tailgate 10 is arranged in the stowed position with the multi-function tailgate 10 opened, the generally planar work surface 22 and the inner facia 14 provide a useful workspace that can support tools, computers, or other activities as desired.

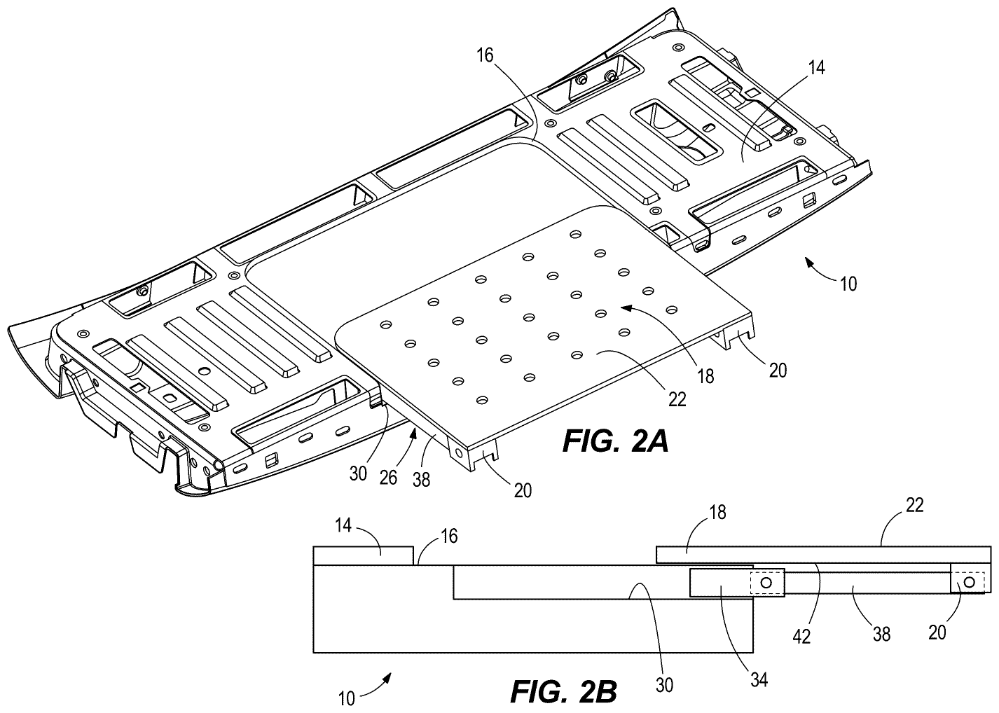

As shown in FIGS. 2A and 2B, the platform 18 can be moved from the stowed position to a work position with the platform 18 extended from the multi-function tailgate 10. The slide link 34 is moved linearly within the slide recess 30 so that the platform 18 is removed at least partially from the facia recess 16 and extends outside the inner facia 14. While in the work position, the platform 18 is supported at least partially, by the pivot links 38 of the slide assembly 26. The work surface 22 is maintained flush with the inner facia 14 such that a workspace is expanded and more usable area is provided for the user. The slide assembly 26 is structured to support tools and activity during use in the work position. For example, a saw or other tool may be mounted to the generally planar work surface 22 for use with the platform 18 in the work position.

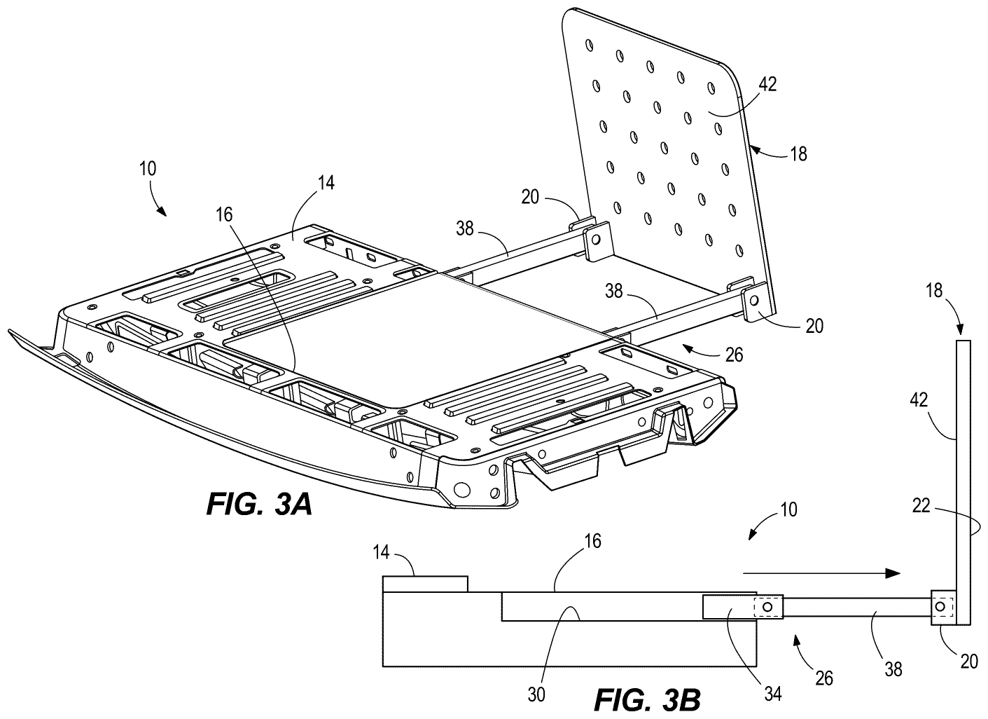

As shown in FIGS. 3A and 3B, the platform 18 can be moved from the work position to a bed extender position with the platform 18 flipped up or rotated on the two platform brackets 20 with the pivot link 38 extended out of the slide recesses 30 and the inner facia 14 to extend the usable space of a truck bed or other storage space. The two platform brackets 20 are shaped to allow rotation between the work position and the bed extender position. In some implementations, the two platform brackets 20 include a detent system that selectively inhibits the platform 18 from moving out of the bed extender position (e.g., spring detents, a latch, etc.). In some implementations, the slide assembly 26 is fully extended when in the bed extender position to provide a maximum available bed space. The platform 18 defines a step surface 42. The step surface 42 is arranged oblique to the inner facia 14 in the bed extender position. In some implementations, the platform 18 is rotated 90 degrees relative to the work position. When rotated 90 degrees, the step surface 42 provides a back stop or wall that inhibits objects from sliding out of a vehicle storage area or bed. In some implementations, the platform 18 can be flipped up when the slide assembly 26 is not extended providing a first extended bed length, and/or flipped up when the slide assembly 26 is extended (as shown) to provide a second, longer extended bed length. In some implementations, the first extended bed length is 8 feet, and the second extended bed length is longer than 8 feet.

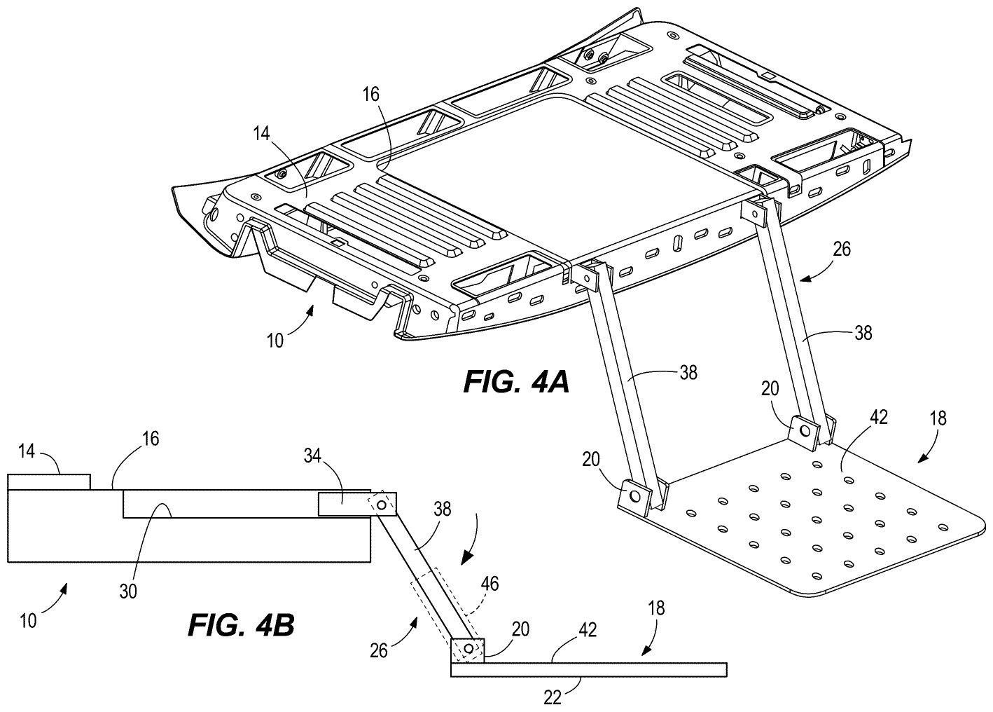

As shown in FIGS. 4A and 4B, the platform 18 can be moved from the bed extender position to a step position with the platform 18 extended from the tailgate inner facia 14 and lowered so that a user can use the step surface 42 to aid entry to the vehicle storage area or bed or use the step surface 42 as a seat. In the bed extender position, the slide link 34 is fully extended in the slide recess 30 to allow the pivot link 38 to rotate relative to the slide link 34. In some implementations, the slide assembly 26 includes an actuator (e.g., a handle, lever, etc.) and/or linkage that allows the pivot link 38 to rotate relative to the slide link 34 (e.g., rotate 135 degrees, 120 degrees to 150 degrees, etc.). The two platform brackets 20 are shaped to limit rotation of the platform 18 relative to the pivot link 38 so that the slide assembly 26 and the platform 18 provide the step surface 42 substantially parallel to a ground plane. In some implementations, the two platform brackets 20 include a detent feature to hold the platform 18 in the bed extender position, and a structural stop defining a maximum rotation that coincides with the step position. The step surface 42 can be used to aid entry into a rear of a vehicle, or as a seat. In some implementations, the step surface 42 is a non-slip surface. In some implementations, the facia recess 16 defines a non-slip surface. In some implementations, the pivot link 38 includes a telescoping feature 46 that can slide relative to the pivot link 38 to move the step surface 42 closer to the ground or otherwise adjust the height of the step surface 42 for use.

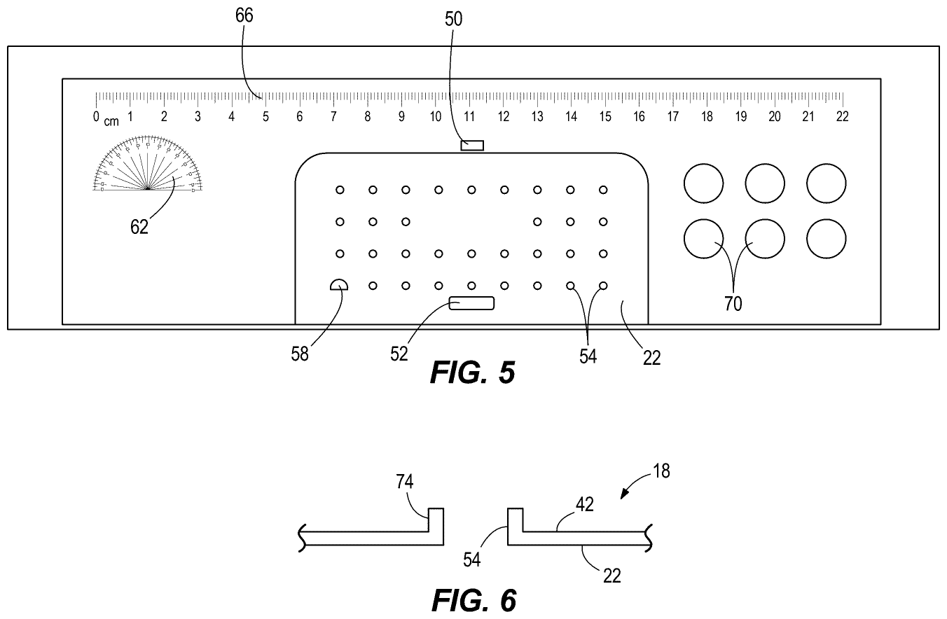

As shown in FIG. 5, in some implementations, the multi-function tailgate 10 includes a platform actuator in the form of a platform button release 50 (e.g., a spring-locked button release) and a handle 52 that provide actuation between the stowed position, the work position, the bed extender position, and the step position. The platform 18 also includes an array of holes 54 that are flat on the work surface 22 and provide a gripping structure on the step surface 42. In some implementations, the holes 54 are 16-millimeter standard holes for tools and clamps allowing the user to secure work items (e.g., a saw, a piece of lumber, etc.) to the platform 18. The platform 18 also includes a bottle opener 58, a protractor 62, a ruler 66, cup holders 70, and/or a pencil groove formed in the inner facia 14. The features of the inner facia 14 can be formed of a non-scuff plastic and provides an extended workspace flush with the generally planar work surface 22.

As shown in FIG. 6, the holes 54 in the platform 18 can include an extended collar 74 that provides a gripping texture or non-slip surface of the step surface 42. The extended collar 74 of each hole 54 is shaped to allow for clamp tools to function therein while providing non-slip advantages.

In some implementations, the work surface 22 includes leaves, ears, and/or multiple layers, so that when it is pulled outward from the vehicle, it can then be extended out on either/both sides. The rough/grip surface of the step surface 42 could be based on use of a different material, or high friction tape. In some implementations, the platform 18 is formed of aluminum. In some implementations, the platform 18 is lockable in each of the stowed position, the work position, the bed extender position, and the step position. In some implementations, the platform 18 is a full width of the multi-function tailgate 10. In some implementations, the multi-function tailgate 10 is positioned on a rear of a vehicle (e.g., to close off a truck bed or a rear storage area of a sport utility vehicle). In some implementations, the multi-function tailgate 10 is positioned on a front of a vehicle (e.g., closing off a front trunk or frunk, etc.).

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A multi-function tailgate comprising:
an inner facia;
a slide assembly coupled to the inner facia; and
a platform coupled to the slide assembly,
wherein the platform is movable between a stowed position, a work position, a bed extender position, and a step position.

2. The multi-function tailgate of claim 1, wherein the inner facia includes a facia recess sized to receive the platform.

3. The multi-function tailgate of claim 2, wherein the platform extends out of the facia recess when arranged in the work position.

4. The multi-function tailgate of claim 1, wherein the platform includes a generally planar work surface that is flush with the inner facia when the platform is in the stowed position and in the work position.

5. The multi-function tailgate of claim 1, wherein the inner facia includes a slide recess sized to receive the slide assembly.

6. The multi-function tailgate of claim 5, wherein the slide assembly includes a slide link slidingly coupled to the slide recess, and a pivot link rotationally coupled to the slide link and rotationally coupled to the platform.

7. The multi-function tailgate of claim 6, wherein the slide link and the pivot link are arranged linearly when the platform is arranged in the work position and the bed extender position.

8. The multi-function tailgate of claim 6, wherein the pivot link is arranged oblique to the slide link when the platform is arranged in the step position.

9. The multi-function tailgate of claim 1, wherein the platform includes two platform brackets rotationally coupled to the slide assembly and limiting rotation of the platform relative to the slide assembly.

10. The multi-function tailgate of claim 1, wherein the platform is rotated oblique to the inner facia when the platform is arranged in the bed extender position.

11. The multi-function tailgate of claim 10, wherein the slide assembly is extended out of the inner facia when the platform is arranged in the bed extender position.

12. The multi-function tailgate of claim 1, wherein the platform includes an array of clamping holes.

13. The multi-function tailgate of claim 12, wherein the clamping holes define a non-slip step surface and an opposing, smooth, generally planar work surface.

14. The multi-function tailgate of claim 1, wherein the inner facia includes a protractor, a ruler, or cup holders.

15. The multi-function tailgate of claim 1, wherein the slide assembly includes a platform button release selectively locking the platform in the stowed position, the work position, the bed extender position, and the step position.

16. A multi-function tailgate comprising:
an inner facia defining a facia recess;
a platform sized to be received within the facia recess and including a generally planar work surface and a step surface; and
a slide assembly including a slide link slidable relative to the inner facia and a pivot link rotationally coupled to the slide link and rotationally coupled to the platform,
wherein the multi-function tailgate is moveable between:
a stowed position with the platform received within the facia recess and the generally planar work surface flush with the inner facia,
a work position with the slide link and the pivot link linearly aligned and extending at least partially from the inner facia so that the generally planar work surface of the platform extends at least partially out of the facia recess with the generally planar work surface flush with the inner facia, and
a step position with the slide link extended from the inner facia, the pivot link rotated relative to the slide link, and the platform rotated relative to the pivot link so that the step surface is usable as a step.

17. The multi-function tailgate of claim 16, wherein the multi-function tailgate is further moveable to a bed extender position with the platform rotated relative to the pivot link so that the step surface is arranged oblique to the inner facia.

18. The multi-function tailgate of claim 16, wherein the platform includes an array of clamping holes.

19. A multi-function tailgate comprising:
an inner facia;
a slide assembly slidably coupled to the inner facia; and
a platform rotationally coupled to the slide assembly and including a work surface and a step surface,
wherein the multi-function tailgate is moveable between:
a stowed position with the work surface flush with the inner facia,
a work position with the slide assembly extending at least partially from the inner facia and the work surface flush with the inner facia and extending therefrom to increase a usable area of the multi-function tailgate,
a bed extender position with the platform rotated relative to the slide assembly so that the step surface is arranged oblique to the inner facia, and
a step position with the platform rotated relative to the slide assembly so that the step surface is usable as a step.

20. The multi-function tailgate of claim 19, wherein the step surface is parallel to and offset from the inner facia in the step position.
